(19) United States
(12) Patent Application Publication
(10) Pub. No.: US 2015/0055879 A1
(43) Pub. Date: Feb. 26, 2015

(54) Method, Server and System for Setting Background Image

(71) Applicant: Alibaba Group Holding Limited, Grand Cayman (KY)

(72) Inventor: Yang Yang, Beijing (CN)

(21) Appl. No.: 14/464,606

(22) Filed: Aug. 20, 2014

(30) Foreign Application Priority Data
Aug. 21, 2013 (CN) 201310366982.1

(51) Int. Cl. G06F 17/30; G06K 9/00

(52) U.S. Cl. CPC G06F 17/30256; G06K 9/00536
USPC 382/217

(57) ABSTRACT

The present disclosure provides an example method, server, or system of setting a background image. The server includes a receiving module, an inquiring module, and a sending module. The receiving module receives image characteristic information sent by a client device. The inquiring module searches a background image that matches the image characteristic information from a preset background image database. The sending module sends the background image that matches the image characteristic information to the client device so that the client device may use the background image as a desktop background. The present techniques intelligently set the desktop background or subject of the client device according to current information of the client device, thereby enabling automatic configuration of individualized desktop background at the client device.

### CROSS REFERENCE TO RELATED PATENT APPLICATIONS

This application claims foreign priority to Chinese Patent Application No. 201310366982.1 filed on 21 Aug. 2013, entitled “Method, Related Server and System of Setting Background Image,” which is hereby incorporated by reference in its entirety.

### TECHNICAL FIELD

The present disclosure is related to the field of setting background image, and more particularly, to a method, server, and system of setting background image.

### BACKGROUND

More and more terminal devices have recently been equipped with cameras. For example, many cell phones, laptops, computers, intelligent TVs are equipped with front cameras. The cell phones and tablets (Pad) may also be equipped with rear cameras. The front camera can capture a face image or clothing of a user and the rear camera can capture a surrounding view. Some rotatable cameras can capture images in a wider area.

Under conventional techniques, a change of a background image or a subject image at a terminal device is manually selected by a user or randomly applied. If the user wishes that the background image of the terminal device changes along with a change of current information (such as people emotions, clothes, surrounding environment, etc.), the user has to manually select a matching background image or subject image locally or through a network, and manually uses the found background image or subject image to update the previous background image or subject image.

In general, conventional techniques only allow the user to manually change the background image or the subject image at the terminal device and cannot intelligently set the background image or the subject image according to the current information.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present techniques improve diversity of results in the direction technology.

The present disclosure provides a method, server, and system of setting a background image. The present techniques intelligently set the background image or a subject according to current information of a device.

To solve the technical problem, the present disclosure provides an example server which includes a receiving module, an inquiring module, and a sending module. The receiving module receives image characteristic information sent by a client device. The inquiring module searches a background image that matches the image characteristic information from a preset background image database. The sending module sends the background image that matches the image characteristic information to the client device so that the client device may use the background image as a desktop background.

The server may also include the background image database that stores multiple background images. Each background image includes a tag that identifies characteristics of the background image.

For example, the inquiring module maps the image characteristics information with tags of the background images, and finds a background image that matches all image characteristics information or a number of image characteristics information. The number meets a preset threshold. For instance, the threshold may be a positive integer or a percentage.

For example, the image characteristics information may include any one of the following or a combination thereof: figure characteristics information, figure clothes characteristics information, scenario characteristics information, and weather characteristics information.

For example, the client device receives the background image and sets the background image as the desktop background.

The present disclosure also provides an example system that includes a client device, which collects an image and extracts image characteristic information of the image according to a preset method, and a server. The server includes a receiving module, an inquiring module, and a sending module. The receiving module receives image characteristic information sent by the client device. The inquiring module searches a background image that matches the image characteristic information from a preset background image database. The sending module sends the background image that matches the image characteristic information to the client device so that the client device may use the background image as a desktop background.

The server may also include the background image database that stores multiple background images. Each background image includes a tag that identifies characteristics of the background image.

For example, the inquiring module maps the image characteristics information with tags of the background images, and finds a background image that matches all image characteristics information or a number of image characteristics information. The number meets a preset threshold. For instance, the threshold may be a positive integer or a percentage.

For example, the image characteristics information may include any one of the following or a combination thereof: figure characteristics information, figure clothes characteristics information, scenario characteristics information, and weather characteristics information.

For example, the client device receives the background image and sets the background image as the desktop background.

The present disclosure also provides an example method of setting a background image that is applicable in a client and server network environment. The server receives image characteristic information sent by a client device. The server searches a background image that matches the image characteristic information from a preset background image database. The server sends the background image that matches the image characteristic information to the client device so that the client device may use the background image as a desktop background.

The example method may also include presetting the background image database. The background image database stores multiple background images. Each background image includes a tag that identifies characteristics of the background image.

For example, the operations that the server searches the background image that matches the image characteristic information from the background image database may include the following. The server maps the image characteristics information with tags of the background images, and finds a background image that matches all image characteristics information or a number of image characteristics information. The number meets a preset threshold. For instance, the threshold may be a positive integer or a percentage.

For example, the image characteristics information may include any one of the following or a combination thereof: figure characteristics information, figure clothes characteristics information, scenario characteristics information, and weather characteristics information.

For example, before the server receives the image characteristic information sent by the client device, the example method may also include the following operations. The client device collects an image and extracts the image characteristic information of the image according to a preset method, and sends the image characteristic information to the server.

For example, the example method may also include the following operations. The client device receives the background image and sets the background image as the desktop background.

The present disclosure also provides another example method of setting a background image. Image characteristic information is received from a client device. A background image that matches the image characteristic information is searched from a preset background image database. The background image that matches the image characteristic information is sent to the client device so that the client device may use the background image as a desktop background.

The example method may also include presetting the background image database. The background image database stores multiple background images. Each background image includes a tag that identifies characteristics of the background image.

For example, the operations searching the background image that matches the image characteristic information from the background image database may include the following. The image characteristics information is matched with tags of the background images, and a background image that matches all image characteristics information or a number of image characteristics information is searched. The number meets a preset threshold. For instance, the threshold may be a positive integer or a percentage.

For example, the image characteristics information may include any one of the following or a combination thereof: figure characteristics information, figure clothes characteristics information, scenario characteristics information, and weather characteristics information.

In the above example embodiments, the present techniques use a server to receive image characteristic information sent by a client device. The server searches a background image that matches the image characteristic information from a preset background image database. The server sends the background image that matches the image characteristic information to the client device so that the client device may use the background image as a desktop background. The present techniques intelligently set the desktop background or subject of the client device according to current information of the client device, thereby enabling automatic configuration of individualized desktop background at the client device.

### BRIEF DESCRIPTION OF THE DRAWINGS

The FIGS. in the present disclosure are briefly described below to better illustrate the present techniques and are part of the present disclosure. The example embodiments and their explanations are used to illustrate the present disclosure and should not be used to impose improper restriction to the present disclosure.

FIG. 1 is a diagram illustrating an example system in accordance with the present disclosure.

FIG. 2 is a diagram illustrating an example client device in accordance with the present disclosure.

FIG. 3 is a flowchart illustrating a first example method of setting a background image in accordance with an example embodiment of the present disclosure.

FIG. 4 is a flowchart illustrating a second example method of setting the background image in accordance with another example embodiment of the present disclosure.

FIG. 5 is a flowchart illustrating a third example method of setting the background image in accordance with another example embodiment of the present disclosure.

### DETAILED DESCRIPTION

The following description describes the present disclosure with reference to the accompanied FIGS. to clearly illustrate the purpose, technical plans, and advantages of the present disclosure. The described example embodiments are just a portion of embodiments instead of all embodiments of the present disclosure. Based on the example embodiments of the present disclosure, one of ordinary skill in the art may obtain other embodiments without using creative efforts, which are also under protection scope of the present disclosure.

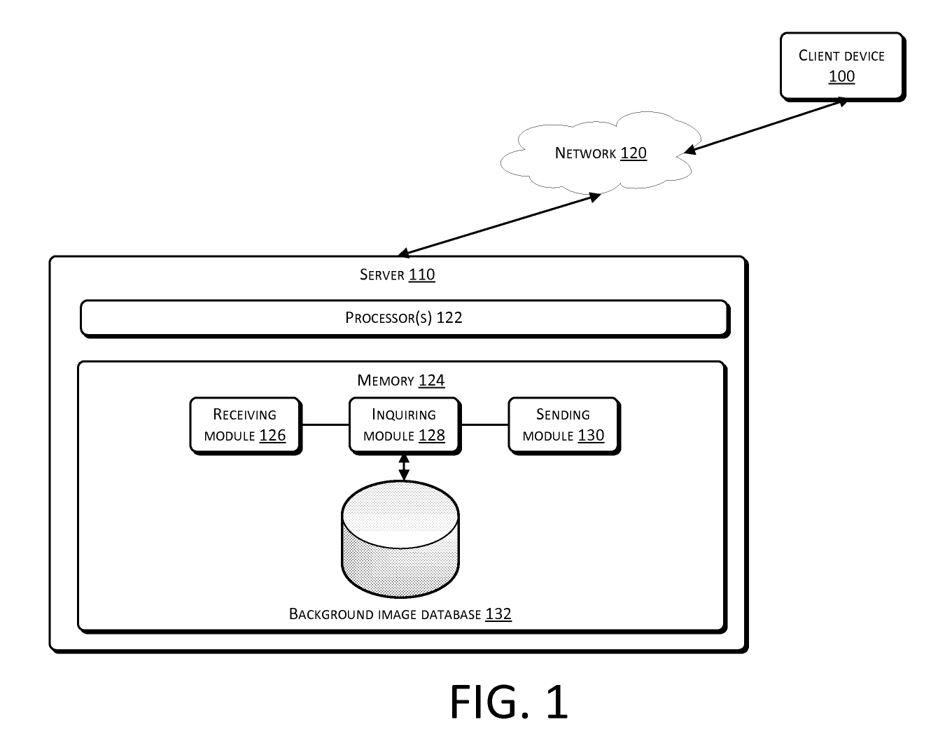

Referring to FIG. 1, the present disclosure provides an example system. FIG. 1 is a diagram illustrating an example system in accordance with the present disclosure. The system includes a client device 100 and a server 110. The client device 100 and the server 110 are connected through a network 120. In an actual implementation, the network 120 may be a wired network or a wireless network. The present disclosure does not impose any restriction to the network 120 herein.

The client device 100 collects an image and uses a preset method to extract image characteristic information of the image. For example, the client device 100 may include, but is not limited to, a cell phone, a personal digital assistant (PDA), a tablet or PAD, a laptop, an intelligent TV, or any other client device that has an image collection function. Equipment that implements the image collection function may be a camera. The client device 100 may, through its camera (a front camera or a rear camera), capture video information (such as 2 seconds video) or photo information (such as one or more photos) and extract the image characteristic information of the image by, for example, calculating characteristic codes of the collected image.

For example, the image characteristics information may include, but is not limited to, figure characteristics information, figure clothes characteristics information, scenario characteristics information, or weather characteristics information. For instance, a figure image identification algorithm may be used to separate the figure and a clothing color of the figure is output as the characteristic codes. A face recognition algorithm may be used to identify an emotion of the figure and the emotion is output as a characteristic code. A background of the image is analyzed to identify a tone of the background and the tone of the background of the image is output as a characteristic code. A combination of the above algorithms or other algorithms may be used to comprehensive calculate a characteristic code of the image. The present disclosure does not impose any restriction on calculating the image characteristic information. The client device 100, through the network 120, sends the image characteristic information to the server 110.

Optionally, the server 110 may be a cloud server or a server that has cloud computing functions or provides cloud computing services. Referring to FIG. 1, the server 110 may include one or more processor(s) 122 or data processing unit(s) and memory 124. The memory 124 is an example of computer-readable media. The memory 124 may store therein a plurality of modules including a receiving module 126, an inquiring module 128, and a sending module 130, and a background image database 132. The receiving module 126 receives the image characteristic information sent by the client device 100 and sends the image characteristics information to inquiring module 128. The inquiring module 128 is coupled with the receiving module 126 and searches a background image that matches the image characteristic information from a preset background image database. The sending module 130 is coupled with the inquiring module 128 and sends the background image that matches the image characteristic information to the client device 100.

The background image database 132 stores multiple background images. The background image may be a static or dynamic background image. Each background image includes a tag that identifies characteristics of the background image. Each background image stored in the background image database 132 may have one or more tags. Each tag identifies a particular characteristic of the background image. The present disclosure does not impose any restriction to a number of the tags. In a practical implementation, the tags of each background image may be added or deleted anytime. For example, the tags of the background image may be added manually or automatically through a machine learning algorithm. It should be noted that the background image database in the present disclosure may be a separate apparatus or integrated with the server. In addition, the background image database may be implemented as a relational database or any other type of database.

For example, the image characteristic information received by the receiving module 126 may include multiple characteristic information of the image. The background images stored at the background image database 132 also include multiple labels. When the inquiring module 128 conducts inquiry to map between the characteristic information of the image and the background images, a complete match or a fuzzy match may be used. The complete match is that the image characteristic information and the tags of the background image completely matches. The fuzzy match is that a number of information in the image characteristic information that matches the tags of the background image meets a preset threshold. For instance, image characteristic information of an example image includes two pieces of characteristic information such that the figure is a girl and the clothing color is red. If tags of a particular background image match all of the above image characteristic information, it is a complete match. For another instance, image characteristic information of another example image includes four pieces of characteristic information such that the figures are children, the figure emotion is smile, the background is grass, and the weather is sunny. Another particular background image has two tags including that the figures are children and the background is grass. Then this results in a fuzzy match between the two. In the fuzzy match, a condition threshold may be set for the fuzzy match, such as a positive integer or a percentage. The threshold may be preset. A range of the threshold may be determined according to specific circumstance. When the fuzzy match meets the threshold, there is a deemed match and the image characteristic information matches the particular background image.

The client device 100 receives the background image sent by the sending module 130 of the server 110 and sets the received background image as a desktop background at the client device 100. It should be noted that the client device 100 may set the received background image as any other background at the client device 100 such as a background for messaging and chatting.

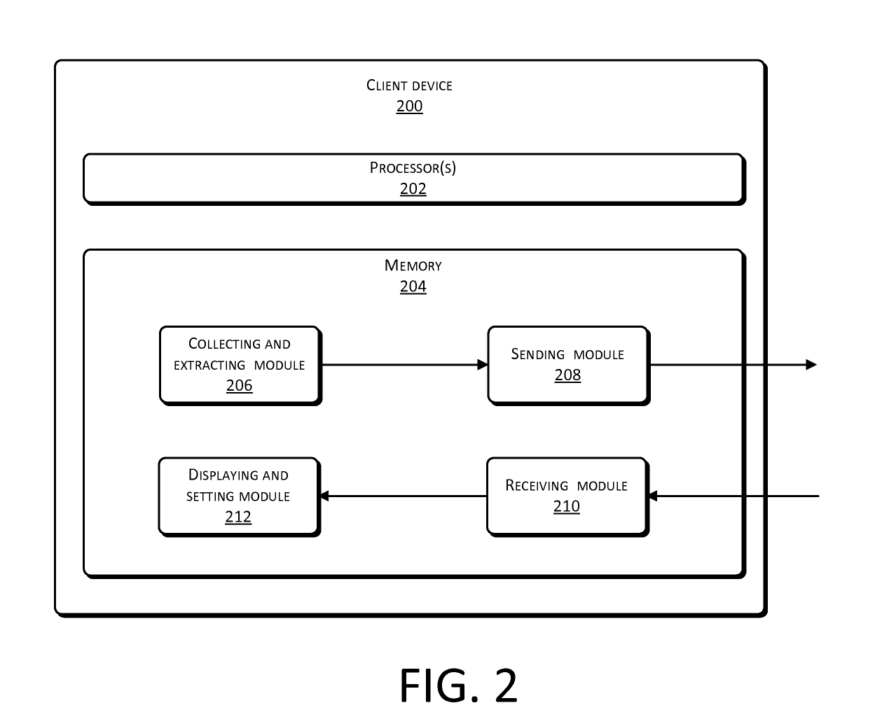

FIG. 2 is a diagram illustrating an example client device 200 in accordance with the present disclosure. In the example of FIG. 2, the client device 200 may include one or more processor(s) 202 or data processing unit(s) and memory 204. The memory 204 is an example of computer-readable media. The memory 204 may store therein a plurality of modules including a collecting and extracting module 206, a sending module 208, a receiving module 210, and a displaying and setting module 212.

The collecting and extracting module 206 collects an image and extracts image characteristic information of the image according to a preset method. The sending module 208 is coupled with the collecting and extracting module 206 and sends the image characteristic information to the server 110. The receiving module 210 receives a background image sent by the server 110. The displaying and setting module 212 is coupled with the receiving module 210 and sets the background image received by the receiving module 210 as a desktop background.

In the above example embodiments, the server, such as a network server, searches the corresponding background image according to the current information at the client device and sends the background image to the client device so that the client device may display the desktop background that corresponds to the current information, thereby enabling automatic configuration of individualized desktop background at the client device.

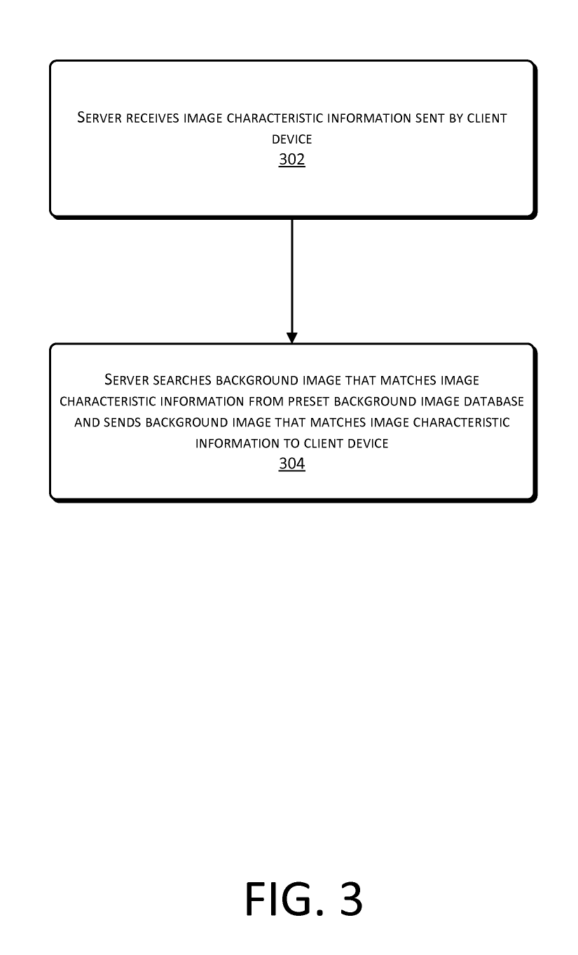

The present disclosure also provides an example method of setting the background image. Such method may be applicable at a network environment including the client device and the server. FIG. 3 is a flowchart illustrating a first example method of setting a background image in accordance with an example embodiment of the present disclosure.

At 302, the server receives image characteristic information sent by a client device. For example, the image characteristics information may include any one of the following or a combination thereof: figure characteristics information, figure clothes characteristics information, scenario characteristics information, and weather characteristics information.

At 304, the server searches a background image that matches the image characteristic information from a preset background image database. The server sends the background image that matches the image characteristic information to the client device so that the client device may use the background image as a desktop background.

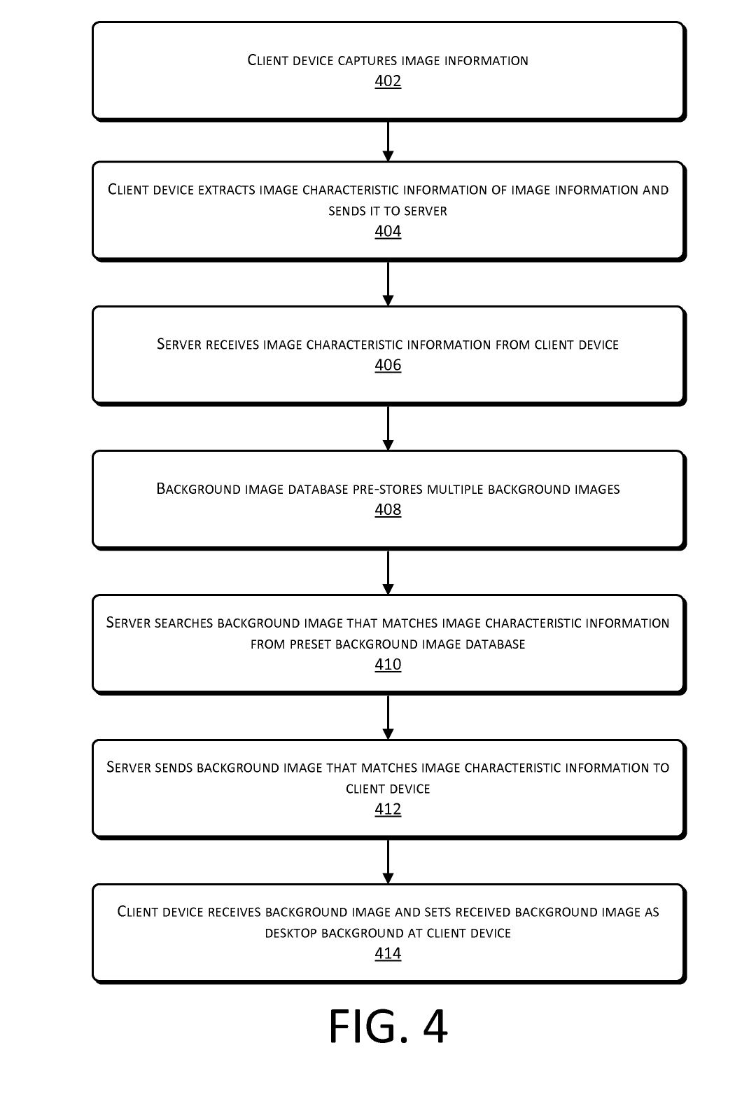

Referring to FIG. 4, the details of the above operations are described. FIG. 4 is a flowchart illustrating another example method of setting the background image in accordance with another example embodiment of the present disclosure.

At 402, the client device captures video information within a period of time or photo information and obtains image information.

At 404, the client device calculates image characteristic information of the image information according to a preset method and sends effective image characteristic information to the server through the network.

At 406, the server receives the image characteristic information from the client device.

At 408, the background image database pre-stores multiple background images. Each background image includes one or more tags that identify characteristics of the background image. It should be noted that operations at 408 are only required to be conducted prior to operations at 410 and have no strict sequential relationship with the operations from 402 to 406.

At 410, the server searches the background image that matches the image characteristic information from the background image database. For example, the server matched the image characteristics information with the tags of the background images, and finds a background image that matches all image characteristics information or a number of image characteristics information. The number meets a preset threshold. For instance, the threshold may be a positive integer or a percentage.

At 412, the server sends the background image that matches the image characteristic information to the client device.

At 414, the client device receives the background image and sets the received background image as a desktop background at the client device.

The present disclosure provides example methods of setting the background image. Such methods may be applicable to the server. Optionally, the server may be a cloud server or a server that has cloud computing functions or provides cloud computing services.

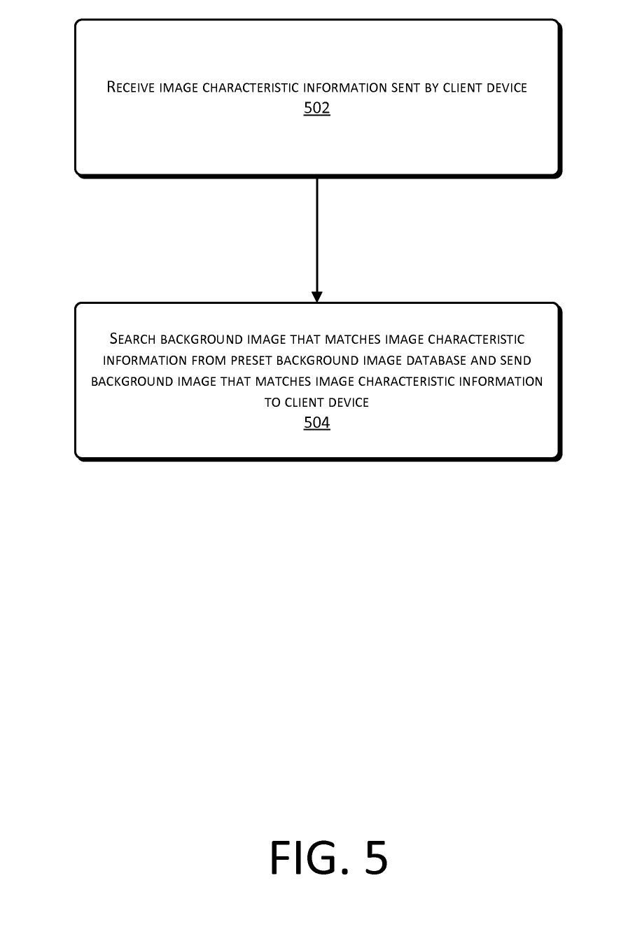

FIG. 5 is a flowchart illustrating yet another example method of setting the background image in accordance with yet another example embodiment of the present disclosure.

At 502, image characteristic information from the client device is received. For example, the image characteristics information may include any one of the following or a combination thereof: figure characteristics information, figure clothes characteristics information, scenario characteristics information, and weather characteristics information.

At 504, a background image that matches the image characteristic information is searched from a preset background image database. The background image that matches the image characteristic information is sent to the client device so that the client device may use the background image as a desktop background.

For example, the background image database is preset. The background image database stores multiple background images. Each background image includes a tag that identifies characteristics of the background image. The image characteristics information is matched with tags of the background images, and a background image that matches all image characteristics information or a number of image characteristics information is searched. The number meets a preset threshold. For instance, the threshold may be a positive integer or a percentage. A range of the threshold may be determined according to specific circumstance. The background image that matches the image characteristic information is sent to the client device so that the client device may use the background image as a desktop background.

The operations at the example methods correspond to relevant diagrams and characteristics of the example server and system of the present disclosure and may be referenced to each other. For the purpose of brevity, the details are not described herein.

In the above example embodiments, the present techniques use the server to receive image characteristic information sent by the client device. The server searches a background image that matches the image characteristic information from a preset background image database. The server sends the background image that matches the image characteristic information to the client device so that the client device may use the background image as a desktop background. The present techniques intelligently set the desktop background or subject of the client device according to current information of the client device, thereby enabling automatic configuration of individualized desktop background at the client device.

In a standard configuration, a computing device, such as the server or the client device, as described in the present disclosure may include one or more central processing units (CPU), one or more input/output interfaces, one or more network interfaces, and memory.

The memory may include forms such as non-permanent memory, random access memory (RAM), and/or non-volatile memory such as read only memory (ROM) and flash random access memory (flash RAM) in the computer-readable media. The memory is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

It should be noted that the term “including,” “comprising,” or any variation thereof refers to non-exclusive inclusion so that a process, method, product, or device that includes a plurality of elements does not only include the plurality of elements but also any other element that is not expressly listed, or any element that is essential or inherent for such process, method, product, or device. Without more restriction, the elements defined by the phrase “including a . . . ” does not exclude that the process, method, product, or device includes another same element in addition to the element.

One of ordinary skill in the art would understand that the example embodiments may be presented in the form of a method, a system, or a computer software product. Thus, the present techniques may be implemented by hardware, computer software, or a combination thereof. In addition, the present techniques may be implemented as the computer software product that is in the form of one or more computer storage media (including, but is not limited to, disk, CD-ROM, or optical storage device) that include computer-executable or computer-readable instructions.

Although the present disclosure describes the example embodiments, one of ordinary skill in the art could make changes and modifications to the example embodiments once he/she know those basic creative concepts as described herein. Thus, the appended claims shall be construed to cover the example embodiments and all changes and modifications that fall into the scope of the present disclosure.

Furthermore, one of ordinary skill in the art may make any revisions or variations to the present techniques without departing the spirit and scope of the present techniques. Thus, in case such revisions or variations fall under the scope of the claims of the present techniques and its equivalent techniques, the present disclosure also intends to cover such revisions or variations.

What is claimed is:

1. A server comprising:
a receiving module that receives image characteristic information sent by a client device;
an inquiring module that searches a background image that matches the image characteristic information from a preset background image database; and
a sending module that sends the background image that matches the image characteristic information to the client device.

2. The server of claim 1, further comprising the background image database that stores multiple background images, each background image including one or more tags that identify one or more characteristics of the background image.

3. The server of claim 2, wherein the inquiring module maps the image characteristics information with the one or more tags of the background images, and finds a background image that matches a number of image characteristics information, the number meeting a preset threshold.

4. The server of claim 3, wherein the threshold is a positive integer or a percentage.

5. The server of claim 1, wherein the image characteristics information includes one or more of the following:
figure characteristics information;
figure clothes characteristics information;
scenario characteristics information; and
weather characteristics information.

6. A client device comprising:
a collecting and extracting module that collects an image and extracts image characteristic information of the image;
a sending module that sends the image characteristic information to a server;
a receiving module that receives a background image sent by the server; and
a displaying and setting module that sets the background image received by the receiving module as a desktop background.

7. The client device of claim 6, further comprising a camera that captures the image.

8. The client device of claim 6, wherein the server searches the background image that matches the image characteristic information from a preset background image database.

9. The client device of claim 1, wherein the image characteristics information includes one or more of the following:
figure characteristics information;
figure clothes characteristics information;
scenario characteristics information; and
weather characteristics information.

10. A method comprising:
receiving image characteristic information sent by a client device; and
searching a background image that matches the image characteristic information from a preset background image database.

11. The method of claim 10, further comprising sending the background image to the client device.

12. The method of claim 10, further comprising presetting the background image database that stores multiple background images, each background image including one or more tags that identify one or more characteristics of the background image.

13. The method of claim 12, wherein the searching the background image that matches the image characteristic information from the preset background image database comprises:
mapping the image characteristics information with the one or more tags of the background images; and
finding a background image that matches a number of image characteristics information, the number meeting a preset threshold.

14. The method of claim 12, wherein the threshold is a positive integer.

15. The method of claim 12, wherein the threshold is a percentage.

16. The method of claim 10, wherein the image characteristics information includes one or more of the following:
figure characteristics information;
figure clothes characteristics information;
scenario characteristics information; and
weather characteristics information.

17. The method of claim 10, further comprising:
capturing an image; and
extracting the image characteristic information of the image.

18. The method of claim 10, where the image includes a photo.

19. The method of claim 10, where the image includes a video.

20. The method of claim 10, further comprising setting the background image as a desktop background at the client device.
